(19) United States
(12) Patent Application Publication
(10) Pub. No.: US 2014/0278733 A1
(43) Pub. Date: Sep. 18, 2014

(54) RISK MANAGEMENT METHODS AND SYSTEMS FOR ENTERPRISE PROCESSES

(71) Applicant: Navin Sabharwal, New Delhi (IN)

(72) Inventor: Navin Sabharwal, New Delhi (IN)

(21) Appl. No.: 13/841,985

(22) Filed: Mar. 15, 2013

(51) Int. Cl. G06Q 10/06

(52) U.S. Cl. CPC G06Q 10/0635
USPC 705/7.28

(57) ABSTRACT

Methods and systems are provided to manage risk in an enterprise process by performing quantitative risk assessment for a plurality of enterprise resource categories, including a human resource category, that contribute to performance of the process. A plurality of risk values for the respective resource categories are thus determined. Risk assessment is performed based on a comparative analysis of the respective resource category risk values. Quantitative risk assessment for the human resource category comprises calculating an assessed knowledge metric value that indicates measured knowledge of people that contribute to the process, and quantifying a knowledge risk by correlating the assessed knowledge metric value with predefined knowledge metric thresholds.

### BACKGROUND

Management of risks in an organization, such as a business enterprise, can be of critical importance to success of the organization. To this end, risk management and business enterprise is often include attempts and providing objective risk identification, which may include quantifying various risks to facilitate risk assessment.

While the performance metrics and associated risks of certain aspects of business enterprises are readily quantifiable, other aspects that contribute to an enterprise process are often less susceptible to objective quantification, so that risks to the enterprise process originating from such aspects can be overlooked.

### BRIEF DESCRIPTION OF DRAWINGS

Some embodiments are illustrated by way of example and not limitation in the figures of the accompanying drawings, in which like reference numerals indicate like components. In the drawings:

FIGS. 1A and 1B are schematic flow charts that together illustrate an example embodiment of a method of risk management for an enterprise process.

FIG. 2 depicts an example graphical user interface that may be displayed by a risk management system in accordance with an example embodiment.

FIG. 3 depicts an example embodiment of a risk rating matrix that may be employed in accordance with an example method of risk management for enterprise processes.

FIG. 4 is a high-level schematic diagram of an enterprise process risk management system, in accordance with another example embodiment.

FIG. 5 is a schematic block diagram of an environment in which an enterprise process risk management system may be provided, in accordance with another example embodiment.

FIG. 6 is a schematic block diagram of selected components of an enterprise risk management system accordance with an example embodiment.

FIG. 7 is a diagrammatic representation of a machine in the example form of a computer system within which a set of instructions for causing the machine to perform any one or more of the methodologies discussed herein may be executed.

### DETAILED DESCRIPTION

Example methods and systems to manage risks to an enterprise process will now be described. In the following description, for purposes of explanation, numerous specific details are set forth in order to provide a thorough understanding of example embodiments. It will be evident, however, to one skilled in the art that many other embodiments the fall within the scope of the present disclosure may be practiced without these specific details.

Example embodiments provide for the assessment of risk in an organization, such as a business enterprise, to facilitate management of risks to an enterprise process, such as business process. In this example, the objective of performing risk assessment is to enable the organization to accomplish effective information technology service management (ITSM).

The example embodiments that are described below provide multifaceted risk assessment, in which risk values at different levels of granularity are generated for multiple component categories or facets of the relevant enterprise process. For example, hierarchical composite risk quantification may be provided for in associated business categories that include, thr example, the process per se, technology used by the enterprise of performing a process, human resource of the enterprise, and measurable deliverables of the process, such as defined key performance indicators (KPIs).

The example methods may thus include performing quantified risk assessment with respect to an enterprise resource category comprising human resources. Quantification of risks associated with the human resources category may include quantifying knowledge risks associated with measured knowledge levels of human resource elements (e.g., people), compared to predefined threshold values associated with knowledge risk.

A number of attributes or aspects may be defined for each enterprise category, so that this quantification may be performed for each of these attributes of the respective business categories. Such more granular risk values may be aggregated or rolled up to provide quantified risk values for higher-level entities, such as for the corresponding resource category, for the particular enterprise process, and/or for the enterprise globally.

Risk quantification may comprise identifying one of a number of predefined risk levels that apply to a particular enterprise/resource category/category attribute. Such a risk level may be an indication of the severity of consequences (e.g., the hazard) associated with the relevant risk. The method may include, after determining that a level for the risk's consequences, assessing the respective risks with reference to a likelihood or probability of realization of the risk. Estimation of the risk probability may be performed on the basis of historical evidence or trend analysis using historical data relevant to the particular category or attribute that is assessed.

FIGS. 1A and 1B show a flowchart 100 of an example method of assessing and/or managing enterprise risk. The method comprises identifying a number of resource categories or business areas that form part of the enterprise as a whole, or that contribute to a particular enterprise process, depending on the particular subject of the risk assessment and/or management. In this example, four different categories relevant to an information technology service management process are defined, namely: a technology category 104, key performance indicators (KPI's) 108, the particular process itself 112, and people or human resources (HR) 116.

Analogous processes are followed for each of the categories, to determine or estimate respective attribute risk values or metrics and to determine a composite risk value for the respective categories. For ease of description, these operations will first be described with reference only to the KPI risk category (108), but note that similar or analogous procedures are performed with respect to each of the risk categories.

First, a number of different attributes or facets are defined for each of the defined risk categories, at 118, to permit risk measurement of the respective attributes of each category separately. Table 1 below shows different attributes that are ascribed to the KPI risk component in this example. Note that these attributes, such as average incident response time, percentage of major incidents, incident queue rate, and so forth are relevant to the particular example process (an information technology service), and may be different for other processes or enterprises for which risk is to be assessed or managed.

TABLE 1
Environment Assessment

| | | | Environment | | | |
|---|---|---|---|---|---|---|
| | | | Assessment | Pass | | |
| S. | | Target | Score | (Yes/ | Risk | Risk |
| No | Name | Score | (Actual) | No) | Score | Classification |
| 1 | Vikas | 85 | 76 | No | 2 | Major |
| 2 | Mahesh | 85 | 95 | Yes | 5 | No Risk |
| 3 | Navin | 85 | 100 | Yes | 5 | No Risk |
| 4 | Aush | 85 | 69 | No | 1 | Extreme |
| 5 | Prshant | 85 | 89 | Yes | 4 | Low Risk |
| 6 | Digant | 85 | 86 | Yes | 4 | Low Risk |
| 7 | Vandana | 85 | 91 | Yes | 4 | Low Risk |
| 8 | Neha | 85 | 72 | No | 2 | Major |
| 9 | Ganesh | 85 | 88 | Yes | 4 | Low Risk |
| 10 | Soundappan | 85 | 70 | No | 2 | Major |

Thereafter, attribute threshold values are defined, at 120, based on historical data or based on the client/stakeholders expectations. The definition of attribute threshold values may comprise defining a predefined number of performance metric intervals to permit objective measurement of risk for the associated attribute in one of a limited number of predefined risk levels. The attribute performance metric intervals for the KPI attribute in the present example are shown in Table 1. With respect to KPIs, the attribute threshold values are defined with respect to key performance metrics (in this instance corresponding to each attribute of the KPI risk category) based on historical data and/or based on client/stakeholders expectations.

As will be evident from the description that follows, this example embodiment defines five risk levels, indicated by integers 1 through 5. Here, a lower risk value indicates a higher risk, so that risk level 1 indicates the highest risk. Of course, different quantification conventions may be followed in different embodiments.

Rules for risk classification may then be defined against the attribute threshold values, at 122, and the threshold values may be scored based on risk classification, to correlate each attribute metric interval to a risk metric or risk value. Table 2 below shows the example risk rules definition and scoring for the defined attributes thresholds of the KPI risk category:

TABLE 2

| Category | Risk Classification | Score |
|---|---|---|
| Below Threshold | Extreme | 1 |
| Threshold-Target | Major | 2 |
| Target-Stretch 1 | Acceptable | 3 |
| Stretch 1-Stretch 2 | Low Risk | 4 |
| Stretch 2 & above | No Risk | 5 |

Thereafter, values for the relevant performance metrics are calculated, at 126, based on applicable transactional or analytical data. In the instance of KPIs, performance metrics data relevant to the respective attributes may be extracted, and the KPI values may be calculated against the respective key metrics. In this example, the risk management system may be employed for incident management, change management, and/or problem management. The data upon which calculation of the respective performance metrics, at 126, is based may thus differ depending on the particular mode of assessment. In one instance, remedy data is extracted to calculate the actual value of the KPIs against respective key metrics.

The calculated performance metrics can then be compared to the respective defined risk thresholds, to determine the risk level and classification for the respective attributes, and to score the attributes based on the risk level, at 130. Table 3 shows attribute risk level determination arrived at by mapping the calculated actual performance in the respective attributes to the corresponding predefined threshold values based on the applicable predefined risk rules. As indicated schematically by operation 132 in FIGS. 1A and 1B, operations 120 through 130 may be repeated separately for each category attribute.

TABLE 3

| | Actual | | |
|---|---|---|---|
| KPIs | Performance | Score | |
| Average incident response time | 40 | 1 | Risk |
| % of major incidents | 6.80% | 4 | |
| % of outage due to incidents | 3% | 3 | |
| (unplanned unavailability) | | | |
| % of incidents escalated | 8.10% | 2 | Warning |
| Average number of incidents | 27.75 | 3 | |
| resolved by first line | | | |
| operatives (first response) | | | |
| Incident queue rate | 0.01 | 1 | Risk |
| % of incidents fixed before | 72.5% | 5 | |
| users notice | | | |
| % of repeat incidents | 8.1% | 4 | |
| % of overdue incidents | 4% | 4 | |
| % of incidents solved within | 87% | 2 | |
| deadline/target/SLA | | | |

The method may comprise providing multi-layered risk assessment information, e.g. by means of a risk assessment dashboard on a graphical user interface (GUI), in which composite risk values and individual risk values, at different levels of hierarchy in the enterprise, can be accessed by user. To this end, the risk scores for the respective category attributes can be rolled up or aggregated, at 134, to calculate a composite or aggregate risk score for the corresponding risk category. In this example, the calculated risk scores of the KPIs attributes shown in FIG. 3 can be aggregated to provide a composite or aggregate risk score for the KPIs risk category. In this example, aggregation of the attribute risk scores is by taking a statistical average of the constituent attributes, to provide a value between one and five. In other embodiments, aggregation may be by taking a weighted average, a statistical mean, or the like.

The above-described granular aggregational risk scoring method may be repeated, at 136, for each of the defined risk categories, thus producing a composite category risk score for each of the defined enterprise categories, each category risk score in turn comprising multiple constituent category attribute risk scores.

One of the categories for which composite risk value determination may be performed includes a human resources component 116 of the enterprise. Human resource capabilities can be assessed by conducting assessment tests at periodic intervals. Some aspects relevant to human resource risk calculation, such as technical knowledge of the people involved, can be assessed by determining the certification that they respectively hold that are relevant, for example, to the process being assessed.

In this example, the risk attributes, defined at 118, of the human resources category may include knowledge of the relevant process (Process Knowledge), knowledge of the enterprise/process environment (Environment Knowledge), and knowledge of the technical aspects required for performance of the relevant responsibilities (Technical Knowledge). Process Knowledge and Environment Knowledge may be measured by assessment tests performed at a specified interval, while Technical Knowledge can be measured based on certification per process requirement (for example, ITIL-, UNIX/Windows related, or MSCP certifications, or the like).

For the human resources category, the operation of defining attribute threshold values, at 120, may be based on internal enterprise decisions or on client/stakeholders expectations. Tables 4 and 5 show example threshold value definitions for Process Knowledge assessment and Environment Knowledge assessment respectively, while the definition of the human resource risk rules, at 122, may be identical to that described above for the KPIs category. Note, though, that the risk rules definition may, in other instances, be different for different categories of a common process, and/or may be different for different attributes of a common category.

TABLE 4
Process Assessment

| Assessment Score | Risk Number |
|---|---|
| <65% | 1 |
| >=65 & <70 | 2 |
| >=70 & <80 | 3 |
| >=80 & <90 | 4 |
| >=90 | 5 |

TABLE 5
Environment Assessment

| Assessment Score | Risk Number |
|---|---|
| <70% | 1 |
| >=70 & <80 | 2 |
| >=80 & <85 | 3 |
| >=85 & <95 | 4 |
| >=95 | 5 |

Determining performance metric values relevant to the assessment, at 126, may, for the human resources category, comprise conducting assessment tests on process and environment for the Process Knowledge and the Environment Knowledge attributes respectively, and may comprise evaluating the relevant certifications for measuring the Technical Knowledge attributes.

Some category attributes may be subjected to risk assessment at a lower level, so that multiple components of a category attribute may be assessed separately and maybe accorded respective risk scores, at 127, which may then be aggregated, at 128, to determine the corresponding attribute risk score. In the case of human resources, for example, the performance assessment can be performed with respect to individuals that constitute attribute components. Tables 6, 7, and 8 shows such individualized risk classification and risk scoring for a group of individuals that are part of the human resource category. Each individual is assessed for the respective attribute, and is accorded a respective risk score and risk classification, based on the previously defined risk rules and threshold values as is evident from the tables that follow.

TABLE 6
Environment Assessment

| | | | Environment | | | |
|---|---|---|---|---|---|---|
| | | | Assessment | Pass | | |
| S. | | Target | Score | (Yes/ | Risk | Risk |
| No | Name | Score | (Actual) | No) | Score | Classification |
| 1 | Vikas | 85 | 76 | No | 2 | Major |
| 2 | Mahesh | 85 | 95 | Yes | 5 | No Risk |
| 3 | Navin | 85 | 100 | Yes | 5 | No Risk |
| 4 | Aush | 85 | 69 | No | 1 | Extreme |
| 5 | Prshant | 85 | 89 | Yes | 4 | Low Risk |
| 6 | Digant | 85 | 86 | Yes | 4 | Low Risk |
| 7 | Vandana | 85 | 91 | Yes | 4 | Low Risk |
| 8 | Neha | 85 | 72 | No | 2 | Major |
| 9 | Ganesh | 85 | 88 | Yes | 4 | Low Risk |
| 10 | Soundappan | 85 | 70 | No | 2 | Major |

TABLE 7
Technical Assessment

| | | Process | | Additional | | |
|---|---|---|---|---|---|---|
| | | Requirement | ITIL | Technical | Risk | Risk |
| S. No | Name | Certification | Certified | Certification | Score | Classification |
| 1 | Vikas | Yes | No | | 3 | Acceptable |
| 2 | Mahesh | Yes | No | ORACLE | 4 | Low Risk |
| 3 | Navin | Yes | Yes | | 4 | Low Risk |
| 4 | Aush | Yes | No | | 3 | Acceptable |
| 5 | Prshant | Yes | No | PGDCA | 4 | Low Risk |
| 6 | Digant | No | Yes | | 1 | Extreme |
| 7 | Vandana | Yes | No | NETWORK | 4 | Low Risk |
| 8 | Neha | No | No | | 0 | Extreme |
| 9 | Ganesh | Yes | Yes | | 4 | Low Risk |
| 10 | Soundappan | Yes | Yes | | 4 | Low Risk |

TABLE 8
Process Assessment

| | | | Process | | | |
|---|---|---|---|---|---|---|
| | | | Assessment | Pass | | |
| S. | | Target | Score | (Yes/ | Risk | Risk |
| No | Name | Score | (Actual) | No) | Score | Classification |
| 1 | Vikas | 80 | 87 | Yes | 4 | Low Risk |
| 2 | Mahesh | 80 | 88 | Yes | 4 | Low Risk |
| 3 | Navin | 80 | 85 | Yes | 4 | Low Risk |
| 4 | Aush | 80 | 87 | Yes | 4 | Low Risk |
| 5 | Prshant | 80 | 90 | Yes | 5 | No Risk |
| 6 | Digant | 80 | 84 | Yes | 4 | Low Risk |
| 7 | Vandana | 80 | 92 | Yes | 5 | No Risk |
| 8 | Neha | 80 | 86 | Yes | 4 | Low Risk |
| 9 | Ganesh | 80 | 84 | Yes | 4 | Low Risk |
| 10 | Soundappan | 80 | 98 | Yes | 5 | No Risk |

The attribute component risk scores are then aggregated, at operation 128, to provide the respective attribute risk scores, upon which the assignment of risk classification level is based. Table 9 below shows an example attribute risk score values determined by aggregating constituent component risk scores of the human resource elements described above, as well and an example composite category risk score for the human resource category, which is in this example determined by aggregating the attribute risk scores for Process Knowledge, Environment Knowledge, and Technical Knowledge. These operations are schematically indicated by operations 133, 135, and 137 respectively, in FIG. 1A.

TABLE 9

| People Assessment | Risk | Risk |
|---|---|---|
| On | Score | Classification |
| Process | 4.30 | Low Risk |
| Environment | 3.40 | Acceptable |
| Technical | 3.10 | Acceptable |
| Over All Risk Score | 3.60 | Acceptable |

The method may also include determining a risk level or risk classification corresponding to the aggregated category risk score (referred to also, for example in Table 9, as an overall risk score). Separate risk rules and/or threshold values may be defined for the category risk score, but in some examples, the category risk rules and/or threshold values may be calculated by aggregating the risk rules and/or threshold values of the relevant category attributes in a manner similar to the aggregation of the calculated risk scores. An example of such a global risk score can be seen in FIG. 2, which shows an example risk assessment report or risk assessment dashboard 200 that forms part of a graphical user interface on a display screen of a computer device to provide an interactive, layered risk assessment tool in which the calculated risk scores can be viewed at user selected levels of granularity. The method may thus include, at operation 148, display of the risk assessment report.

In FIG. 2, reference numeral 203 indicates that the respective risk categories for which risk assessment is performed. As mentioned above, risk assessment in this example is performed for different scenarios or risk analysis reasons, namely incident management, problem management, and change management. The dashboard 200 displays respective composite category risk scores 206 for each of these analyses. A global risk score, achieved by aggregating the corresponding category risk scores 206 is calculated and displayed for each risk category globally, across analyses (209), as well as for the enterprise globally in each analysis, across categories (212).

The dashboard 200 may be color-coded, so that each value is displayed in a cell having a background color corresponding to the determined risk assessment level. Although it is not shown in the drawings, note that, in the dashboard 200 of FIG. 2, each cell showing a risk score between 1 and 2 has a red background, each cell showing the risk score between 2 and 3 has a yellow background, and each cell showing a risk score between 3 and 4 has a green background. Although none of the example risk values in FIG. 2 has a risk score above 4, the dashboard 200 may be configured to show such cells as having a blue background. Different color coding schemes may be employed in other embodiments.

The dashboard 200 shows the results of the risk determination described above with reference FIGS. 1A and 1B, and allows the user to interactively drill down from a higher level menu to a desired level of detail. Individual KPI levels and values can thus, for example be selected for analysis.

Returning now to FIGS. 1A and 1B, it is shown that the calculated risk scores can be used for further risk assessment. Note that the respective risk scores calculated by the above-described operations provide an indication of the severity of potential consequences of realization of the respective risks or threats. The consequences may be those of different scenarios of assessment, e.g. for considering different change scenarios (such as configuration changes in a configuration management database). Risk assessment may additionally comprise accounting for a likelihood of a particular risk occurring or being realized.

The method may thus include estimating the likelihood of the respective risks, at 160. The risk likelihood estimation may be performed for each of the risk categories, and a risk category attributes described above, and the respective values may be aggregated in similar fashion. Instead, or in addition, risk likelihoods for the defined risk categories may be estimated separately.

In this example, risk likelihood estimation is performed based on historical performance data for associated processes and activities, and the method may thus include retrieving, at 152, historical data relevant to the particular respective risk categories or risk category attributes, as the case may be. The likelihood may be estimated directly on processing the retrieved historical performance data, and/or can include analyzing risk trends, at 156, evidenced by the corresponding historical performance data.

In this example, the estimated risk likelihood is expressed in risk likelihood intervals or bands corresponding in arrangement to the risk scores determined in operations 120 through 144. Estimated risk value is thus expressed, in this example, in five segregated risk likelihood levels.

The risk scores (e.g., corresponding to consequence severity) and the risk likelihood levels (e.g., corresponding to risk realization probability) may be considered in combination in a risk assessment operation, to determine respective risk ratings for each risk category, for each risk category attribute, and or for any particular aggregated risk level or individualized risk component identified for assessment by a business owner or risk assessor.

FIG. 3 shows one example embodiment of a risk rating map or matrix 300 that may be employed in determining a risk rating based on combined consideration of the calculated risk score and estimated risk likelihood level. In this example, the respective risk scores are correlated to five or score levels indicating a severity of impact of the particular risk, should it occur, namely: Extreme, Major, Acceptable, Low Risk, and No Risk. The likelihood levels are indicated as Almost Certain, Likely, Moderate, Unlikely, and Rare. The matrix 300 shown in FIG. 3 may be displayed as part of the graphical user interface to assist risk rating assessment, or may be applied in an automated process by a computer processor. The matrix 300 in this example provides a color-coded heat map showing predefined risk ratings that can be determined by noting the color or corresponding risk rating of a cell of the matrix 300 that corresponds both to the risk score, or impact, and the likelihood level of the particular risk element that is being considered.

A predefined risk rating interpretation may be employed in combination with the risk metrics 300 to guide determination of acceptability of the identified risks. In this example, highest risk rating (corresponding to areas of the matrix 300 that are colored red) may correspond to a risk rating interpretation (that may be displayed to an operator of the graphical user interface) indicating that countermeasures to these risks should be implemented as soon as possible. A second-highest risk rating level (corresponding to the matrix areas that are colored orange) may correspond to an advisory that these risks are high, and that the implementation of countermeasures is recommended. Areas of the matrix 300 that are colored yellow may indicate that the corresponding risks are low, that countermeasure implementation will enhance the process, but that activities are of less urgency than the higher risk ratings. Areas of the matrix 300 that are colored green may indicate that the corresponding elements pose no risk, is that sufficient measures are already in place, and continuous improvement is required. Finally, areas of the matrix 300 that are colored blue may be indicated as having a superior risk rating.

Returning now to FIGS. 1A and 1B, it is shown that the method 100 further comprises identifying, at operation 170, upgrades or countermeasures for implementation in the enterprise and/or the process to mitigate the risks that were identified as having high risk ratings. Note that the provision of risk scoring information, in particular also for human resource components, enables a business owner or operator to find lower level enterprise elements are contributing causes of high risk ratings for enterprise categories or attributes of which they form part, so that the countermeasures or upgrades can be targeted to specific enterprise components or subcomponents.

Such granularized risk assessment information is of particular benefit with respect to human resource components. Consider, for example, that a business owner is enabled readily to identify a particular knowledge area in which insufficient knowledge or training by employees or personnel are resulting in high risk ratings. In such case, countermeasures can comprise amplified training or education targeted at the specific knowledge area, or at the particular employees or employee groups that are identified as having high risk scores and/or ratings.

Implemented countermeasures or upgrades may in due course, or continuously, be re-evaluated, at 174, e.g. based on process monitoring information, to assess the effectiveness of the implement countermeasures. The reevaluation (at 174) may comprise repeat or reiteration of operations 120 through 164, but may typically be based on constant attribute threshold values and the risk rules, so that operations 120 and one and 22 may be excluded in such interactive risk reevaluation.

If it is determined that risk ratings of the identified threats are not reduced, then ineffectiveness of the upgrades/countermeasures are reported, at 180, and alternative countermeasures or upgrades are identified, at operation 170, if, however, it is determined that the risk ratings of the identified threats are reduced, the implemented countermeasures or upgrades are assessed as being effective and implementation thereof may proceed, at 185.

### Example System

An example embodiment of an enterprise process risk management system will now be described with reference to FIGS. 4-7.

FIG. 4 is a high-level entity relationship diagram of an example configuration of an enterprise process risk management system 400. The system 400 may include one or more computer(s) 404 that comprises a risk scoring engine 408 the to perform, for example, the risk scoring, operations described above, and a risk assessment module 420 to facilitate performance of risk assessment for the enterprise process based on comparative analysis of the respective risk values calculated by the risk scoring engine 408.

The risk scoring engine 408 may include a human resources risk module 424 that is configured to perform quantitative risk assessment with respect to the human resources category as one of a plurality of enterprise resource categories for which risk scores are determined by the risk scoring engine 408.

The system 400 may also include one or more databases or memories that provide enterprise process information 416 that is used by the risk scoring engine 408 risk assessment module 420 in performing their respective operations.

Note that although the system 400 illustrated with reference to FIG. 4 shows, for ease of, a single computer, the elements of system 400 may, in other embodiments, be provided by any number of cooperating system elements, such as processors, computers, modules, and memories, that may be geographically dispersed or that may form part of a single unit.

### Example Environment Architecture

FIG. 5 is a schematic network diagram that shows a more detailed view of a enterprise process risk management system 502, in accordance with another example embodiment, with like reference numerals indicating like parts in FIG. 4 and in FIG. 5. FIG. 5 also shows an example environment 500 comprising a client-server architecture within which an example embodiment of the enterprise process risk management system 502 may be provided. It is to be appreciated that the example environment architecture illustrated with reference to FIGS. 5 and 6 is only one of many possible configurations for employing the methodologies disclosed herein. In the embodiment of FIG. 5, the enterprise process risk management system 502 provides server-side functionality, via a network 504 (e.g., via the Internet, a Wide Area Network (WAN), or a Local Area Network (LAN)) to one or more client machines. FIG. 5 illustrates, for example, a web client 506 (e.g., a browser, such as the Internet Explorer browser developed by Microsoft Corporation of Redmond, Wash.), and a programmatic client 508 executing on respective client machines 510 and 512.

An Application Program Interface (API) server 514 and a web server 516 are coupled to, and provide programmatic and web interfaces respectively to, one or more application servers 518. The application servers 518 host one or more enterprise process risk management application(s) 520 (see also FIG. 6). The application server(s) 518 are, in turn, connected to one or more databases server(s) 524 that facilitate access to one or more database(s) that includes information enterprise process information.

The enterprise process risk management system 502 is also in communication with an enterprise IT system 540 that is supported by the process which is the subject of risk assessment. The enterprise IT system 540 may, e.g., include IT components in the form of servers 542, 544, software applications 546, 548, and system databases 550, 552. It will be appreciated that the enterprise system 540 may comprise a large number of process servers 542, 544 and process datastores 550, 552, although FIG. 5 shows only two such process servers 542, 544, for ease of explanation. Further components of the enterprise IT system 540 may include various user devices or endpoint devices such as, for example, user terminals or client computers, software applications executing on user devices, printers, scanners, and the like.

The enterprise process risk management application(s) 520 may provide a number of automated functions for risk management section navigation, and may also provide a number of functions and services to users that access the system 502, for example providing analytics, diagnostic, predictive and management functionality relating to risk management for the enterprise process. Respective modules for providing these functionalities are discussed with reference to FIG. 6 below. While all of the functional modules, and therefore all of the enterprise process risk management application(s) 520 are shown in FIG. 5 to form part of the enterprise process risk management system 502, it will be appreciated that, in alternative embodiments, some of the functional modules or process model applications may form part of systems that are separate and distinct from the customer support system 502, for example to provide outsourced SLA compliance management for a customer support system.

The web client 506 accesses the enterprise process risk management application(s) 520 via the web interface supported by the web server 516. Similarly, the programmatic client 508 accesses the various services and functions provided by the enterprise process risk management application(s) 520 via the programmatic interface provided by the API server 514.

Again, although the example system 502 shown in FIG. 5 employs a client-server architecture, the example embodiments and this disclosure are not limited to such an architecture, and could equally well find application in a distributed, or peer-to-peer, architecture system, for example. The enterprise process risk management application(s) 520 could also be implemented as standalone software programs, not necessarily have networking capabilities.

### Risk Management Application(s)

FIG. 6 is a schematic block diagram illustrating multiple functional modules of the enterprise process risk management application(s) 520 in accordance with one example embodiment. Although the example modules are illustrated as forming part of a single application, it will be appreciated that the modules may be provided by a plurality of applications. The modules of the application(s) 520 may be hosted on dedicated or shared server machines (not shown) that are communicatively coupled to enable communication between server machines. At least some of the modules themselves are communicatively coupled (e.g., via appropriate interfaces) to each other and to various data sources, so as to allow information to be passed between the modules or so as to allow the modules to share and access common data. The modules of the application(s) 520 may furthermore access the one or more databases 526 via the database servers 524.

The system 502 may provide umber of modules to provide various functionalities for performing example methods of risk management in an enterprise process. The modules may thus include the risk scoring engine 408, risk assessment module 420, and human resources risk module 424 such as that described above. The human resources risk module 424 may include a knowledge risk module 615 configured to facilitate assessment of knowledge of human resource elements contributing to the enterprise process, and to quantify and knowledge risk by correlation of the process knowledge to predefined knowledge parameters.

In this embodiment, the knowledge risk module 615 may also include a process knowledge risk module 620 configured to quantify risk associated with knowledge of the particular enterprise process that is assessed, a technology knowledge risk module 625 configured to quantify risk associated with knowledge of technology relevant to performance of the process, and an environment knowledge risk module 630 configured to quantify risk associated with knowledge of a process environment in which the process is performed.

Modules, Components, and Logic of Example Embodiments

Certain embodiments are described herein as including logic or a number of components, modules, or mechanisms. Modules may constitute either software modules, with code embodied on a non-transitory machine-readable medium (i.e., such as any conventional storage device, such as volatile or non-volatile memory, disk drives or solid state storage devices (SSDs), etc.), or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry or in temporarily configured circuitry (e.g., configured by software), may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

FIG. 7 shows a diagrammatic representation of a machine in the example form of a computer system 700 within which a set of instructions, for causing the machine to perform any one or more of the methodologies discussed herein, may be executed. For example, the system 400 (FIG. 4) or any one or more of its components (FIGS. 5 and 6) may be provided by the system 700.

In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU) a graphics processing unit (CPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alpha-numeric input device 712 (e.g., a keyboard), a cursor control device 714 (e.g., a mouse), a disk drive unit 716, an audio/video signal input/output device 718 (e.g., a microphone/speaker) and a network interface device 720.

The disk drive unit 716 includes a machine-readable storage medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting non-transitory machine-readable media.

The software 724 may further be transmitted or received over a network 726 via the network interface device 720.

While the machine-readable medium 722 is shown example embodiment to be a single medium, the term “machine-readable medium” should be taken to include a single medium or multiple media (e.g., a centralized or distributed database and/or associated caches and servers) that store the one or more sets of instructions. The term “machine-readable medium” shall also be taken to include any medium that is capable of storing a set of instructions for execution by the machine and that cause the machine to perform any one or more of the methodologies of this disclosure. The term “machine-readable medium” shall accordingly be taken to include, but not be limited to, solid-state memory devices of all types, as well as optical and magnetic media.

Thus, a system and method to manage risks to an enterprise process. Although these methods and systems have been described with reference to specific example embodiments, it will be evident that various modifications and changes may be made to these embodiments without departing from the broader spirit and scope thereof. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, the disclosed subject matter lies in less than all features of a single disclosed embodiment. Thus, the following claims are hereby incorporated into the Detailed Description, with each claim standing on its own as a separate embodiment.

What is claimed is:

1. A method of managing risk in an enterprise process, the method comprising:
in an automated operation using one or more processors, performing quantitative risk assessment with respect to each of a plurality of enterprise resource categories that contribute collaboratively to performance of the process, to determine risk values for the respective resource categories, the plurality of enterprise resource categories including a human resources category; and
performing risk assessment for the enterprise process based on comparative analysis of the respective resource category risk values.

2. The method of claim 1, wherein performance of the quantitative risk assessment with respect to the human resources category comprises:
assessing knowledge of human resource elements contributing to the enterprise process, to determine an assessed knowledge metric value; and
quantifying a knowledge risk by correlating the assessed knowledge metric value with predefined knowledge metric parameters.

3. The method of claim 1, wherein performance of the quantitative risk assessment with respect to the human resources category comprises quantifying plurality of category attributes corresponding to a plurality of areas of process-relevant knowledge, and aggregating risk values for the respective category attributes to determine the risk value for the human resources category.

4. The method of claim 3, wherein the areas of knowledge that are quantified includes knowledge of the particular enterprise process that is assessed.

5. The method of claim 3, wherein the areas of knowledge that are quantified includes technical knowledge with respect to technology associated with performance of the process.

6. The method of claim 3, wherein the areas of knowledge that are quantified includes knowledge of a process environment in which the process is performed.

7. The method of claim 3, wherein the performance of quantitative risk assessment with respect to the human resources category includes conducting and scoring assessment tests with respect to one or more of the knowledge areas.

8. The method of claim 3, wherein the performance of quantitative risk assessment with respect to the human resources category includes processing certification levels of respective human resource elements.

9. The method of claim 1, further comprising, for each of the plurality of enterprise resource categories:
in an automated operation, performing quantitative risk assessment for each of a plurality of attributes of the resource category, to determine a plurality of respective category attribute risk values, and
aggregating the category attribute risk values of the enterprise category, to determine a composite enterprise category risk value.

10. The method of claim 9, further comprising aggregating the enterprise category risk values of the respective enterprise categories, to determine an aggregated global risk value.

11. The method of claim 9, further comprising determining a risk rating for each category attribute by combined consideration of the corresponding risk value for the category attribute, and an estimated likelihood of occurrence of risk for the relevant category attribute.

12. A system for managing risk in an enterprise process, the system comprising:
a risk scoring engine to perform quantitative risk assessment with respect to each of the plurality of enterprise resource categories that contribute collaboratively to performance of the process, to determine risk values for the respective resource categories, the risk scoring engine comprising a human resources risk module configured to perform quantitative risk assessment with respect to a human resources category as one of the plurality of enterprise resource categories; and
a risk assessment module to facilitate performance of integrated risk assessment for the enterprise process based on comparative analysis of the respective resource category risk values.

13. The system of claim 12, wherein the human resources risk module comprises a knowledge risk module configured to facilitate assessment of knowledge of human resource elements contributing to the enterprise process, and to quantify a knowledge risk by correlation of the process knowledge to predefined knowledge parameters.

14. The system of claim 12, herein the knowledge risk module is configured to:
determine respective knowledge risk values for a plurality of process-relevant knowledge areas, and
aggregate the knowledge risk values for the respective knowledge areas to determine the risk value for the human resources category.

15. The system of claim 14, wherein the human resources risk module comprises a process knowledge risk module configured to quantify risk associated with knowledge of the particular enterprise process that is assessed.

16. The system of claim 14, wherein the human resources risk module comprises a technology knowledge risk module configured to quantify risk associated with knowledge of technology relevant to performance of the process.

17. The system of claim 14, wherein the human resources risk module comprises an environment knowledge risk module configured to quantify risk associated with knowledge of a process environment in which the process is performed.

18. The system of claim 14, wherein the knowledge risk module is configured to facilitate assessment of human resource knowledge based at least in part on scoring assessment tests with respect to one or more of the knowledge areas.

19. The system of claim 14, wherein the knowledge risk module is configured to quantify the knowledge risk based at least in part on processing certification levels of respective human resource elements.

20. The system of claim 12, wherein the risk scoring engine is configured to:
quantify risk for each of a plurality of attributes of the resource category, to determine a plurality of respective category attribute risk values, and
aggregate the category attribute risk values of the enterprise category, to determine a composite enterprise category risk value.

21. The system of claim 20, wherein the risk scoring engine is further configured to aggregate the enterprise category risk values of the respective enterprise categories, to determine an aggregated global risk value.

22. The system of claim 20, wherein the risk assessment module is configured to facilitate determination of a risk rating for each category attribute by combined consideration of,
the corresponding risk value for the category attribute, and
an estimated likelihood of occurrence of risk for the relevant category attribute.

23. A non-transitory machine-readable storage medium storing instructions which, when performed by a machine, cause the machine to:
perform quantitative risk assessment with respect to each of a plurality of enterprise resource categories that contribute collaboratively to performance of the process, to determine risk values for the respective resource categories, the plurality of enterprise resource categories including a human resources category; and
perform risk assessment for the enterprise process based on comparative analysis of the respective resource category risk values.
